(19) United States
(12) Patent Application Publication
(10) Pub. No.: US 2026/0136416 A1
(43) Pub. Date: May 14, 2026

(54) METHOD AND APPARATUS RELATED TO DUAL CONNECTIVITY MEASUREMENTS

(71) Applicant: Nokia Technologies Oy, Espoo (FI)

(72) Inventors: Amaanat ALI, Espoo (FI); Ahmad AWADA, Munich (DE); Srinivasan SELVAGANAPATHY, Bangalore (IN); Ayaz AHMED, Bangalore (IN); Halit Murat GÜRSU, Munich (DE); Umur KARABULUT, Munich (DE); Panagiotis SPAPIS, Munich (DE); Teemu Mikael VEIJALAINEN, Espoo (FI); Sina KHATIBI, Munich (DE)

(21) Appl. No.: 19/115,436

(22) PCT Filed: Sep. 25, 2023
(86) PCT No.: PCT/EP2023/076315

§ 371 Date: Mar. 26, 2025

(30) Foreign Application Priority Data
Sep. 29, 2022 (IN) 202241055896

(51) Int. Cl. H04W 76/15; H04W 24/10

(52) U.S. Cl. CPC H04W 76/15; H04W 24/10

(57) ABSTRACT

A method is disclosed, including: receiving at a master node for a dual connectivity user equipment from a secondary node for the dual connectivity user equipment an indication of one or more frequencies for which the secondary node configures the dual connectivity user equipment to report measurement results to the secondary node; and sending from the master node to the secondary node an indication of one or more measuring and/or reporting parameters for one or more of the one or more frequencies. An apparatus is also disclosed.

### TECHNICAL FIELD

Example embodiments relate to apparatus, a method, and a computer program, and in particular, but not exclusively to apparatus, methods and computer programs related to dual connectivity measurements.

### BACKGROUND

A user equipment with dual connection to a master node and a secondary node is configured for making and reporting measurements by both the master node and the secondary node.

### SUMMARY

A method, comprising: receiving at a master node for a dual connectivity user equipment from a secondary node for the dual connectivity user equipment an indication of one or more frequencies for which the secondary node configures the dual connectivity user equipment to report measurement results to the secondary node; and sending from the master node to the secondary node an indication of one or more measuring and/or reporting parameters for one or more of the one or more frequencies.

The method may further comprise: receiving at the master node from the secondary node an indication of one or more alternative measuring and/or reporting parameters for one or more of the one or more frequencies; and determining at the master node whether to accept use of the one or more alternative measuring and/or reporting parameters by the secondary node.

A method, comprising: sending from a secondary node for a dual connectivity user equipment to a master node for the dual connectivity user equipment an indication of one or more frequencies for which the secondary node configures the dual connectivity user equipment to report measurement results to the secondary node; and receiving at the secondary node from the master node an indication of one or more measuring and/or reporting parameters for one or more of the one or more frequencies.

The method may further comprise: determining at the secondary node whether to accept use of the one or more measuring and/or reporting parameters.

The method may further comprise: in the event of determining not to accept use of the one or more measuring and/or reporting parameters, sending to the master node an indication of one or more alternative measuring and/or reporting parameters for one or more of the one or more frequencies.

A method, comprising: sending from a master node for a dual connectivity user equipment to a secondary node for the dual connectivity user equipment an indication of one or more rules for reporting measurement results or availability of measurement results to the master node for one or more frequencies for which the secondary node configures the dual connectivity user equipment to report measurement results to the secondary node.

A method, comprising: receiving at a secondary node for a dual connectivity user equipment from a master node for the dual connectivity user equipment an indication of one or more rules for reporting measurement results or availability of measurement results to the master node for one or more frequencies for which the secondary node configures the dual connectivity user equipment to report measurements to the secondary node; and sending one or more reporting messages to the master node according to the one or more rules.

The one or more rules may comprise one or more of: a rule to send a reporting message to the master node in response to an event at the secondary node; or a rule to periodically send reporting messages to the master node.

The event at the secondary node may comprise receiving measurement results from the dual connectivity user equipment.

A method, comprising: sending to a dual connectivity user equipment from a master node for the dual connectivity user equipment one or more messages configuring the dual connectivity user equipment to also report to the master node measurement results for one or more of one or more frequencies for which a secondary node for the dual connectivity user equipment configures the dual connectivity user equipment to report measurement results to the secondary node.

The one or more messages may indicate one or more links between one or more measurements configured by the master node and one or more measurements configured by the secondary node.

A method, comprising: receiving at a dual connectivity user equipment from a master node for the dual connectivity user equipment one or more messages configuring the dual connectivity user equipment to also report to the master node measurement results for one or more of the one or more frequencies for which the dual connectivity user equipment is configured by a secondary node for the dual connectivity user equipment to report measurement results to the secondary node.

The one or more messages may indicate one or more links between one or more measurements configured by the master node and one or more measurements configured by the secondary node; and the method may further comprise: in response to generating measurement results for reporting to the master node for measurements configured by the master node and indicated by the master node to be linked to measurements configured by the secondary node, reporting to the master node both the measurement results for the measurements configured by the master node and measurement results for the linked measurements configured by the secondary node.

A master node for a dual connectivity user equipment, the master node comprising: means for receiving from a secondary node for the dual connectivity user equipment an indication of one or more frequencies for which the secondary node configures the dual connectivity user equipment to report measurement results to the secondary node; and means for sending to the secondary node an indication of one or more measuring and/or reporting parameters for one or more of the one or more frequencies.

The master node may further comprise: means for receiving from the secondary node an indication of one or more alternative measuring and/or reporting parameters for one or more of the one or more frequencies; and means for determining whether to accept use of the one or more alternative measuring and/or reporting parameters by the secondary node.

A secondary node for a dual connectivity user equipment, the secondary node comprising: means for sending to a master node for the dual connectivity user equipment an indication of one or more frequencies for which the secondary node configures the dual connectivity user equipment to report measurement results to the secondary node; and means for receiving from the master node an indication of one or more measuring and/or reporting parameters for one or more of the one or more frequencies.

The secondary node may further comprise: means for whether to accept use of the one or more measuring and/or reporting parameters.

The secondary node may further comprise: means for, in the event of determining not to accept use of the one or more measuring and/or reporting parameters, sending to the master node an indication of one or more alternative measuring and/or reporting parameters for one or more of the one or more frequencies.

A master node for a dual connectivity user equipment, the master node comprising: means for sending to a secondary node for the dual connectivity user equipment an indication of one or more rules for reporting measurement results or availability of measurement results to the master node for one or more frequencies for which the secondary node configures the dual connectivity user equipment to report measurement results to the secondary node.

A secondary node for a dual connectivity user equipment, the secondary node comprising: means for receiving from a master node for the dual connectivity user equipment an indication of one or more rules for reporting measurement results or availability of measurement results to the master node for one or more frequencies for which the secondary node configures the dual connectivity user equipment to report measurements to the secondary node; and means for sending one or more reporting messages to the master node according to the one or more rules.

The one or more rules may comprise one or more of: a rule to send a reporting message to the master node in response to an event at the secondary node; or a rule to periodically send reporting messages to the master node.

The event at the secondary node may comprise receiving measurement results from the dual connectivity user equipment.

A master node for a dual connectivity user equipment, the master node comprising: means for sending to the dual connectivity user equipment one or more messages configuring the dual connectivity user equipment to also report to the master node measurement results for one or more of one or more frequencies for which a secondary node for the dual connectivity user equipment configures the dual connectivity user equipment to report measurement results to the secondary node.

The one or more messages may indicate one or more links between one or more measurements configured by the master node and one or more measurements configured by the secondary node.

A dual connectivity user equipment, comprising: means for receiving from a master node for the dual connectivity user equipment one or more messages configuring the dual connectivity user equipment to also report to the master node measurement results for one or more of the one or more frequencies for which the dual connectivity user equipment is configured by a secondary node for the dual connectivity user equipment to report measurement results to the secondary node.

The one or more messages may indicate one or more links between one or more measurements configured by the master node and one or more measurements configured by the secondary node; and the dual connectivity user equipment may further comprise: means for, in response to generating measurement results for reporting to the master node for measurements configured by the master node and indicated by the master node to be linked to measurements configured by the secondary node, reporting to the master node both the measurement results for the measurements configured by the master node and measurement results for the linked measurements configured by the secondary node.

A master node for a dual connectivity user equipment, the master node comprising: at least one processor, and at least one memory including computer program code, the at least one memory and computer program code configured to, with the at least one processor, cause the master node to perform: receiving from a secondary node for the dual connectivity user equipment an indication of one or more frequencies for which the secondary node configures the dual connectivity user equipment to report measurement results to the secondary node; and sending to the secondary node an indication of one or more measuring and/or reporting parameters for one or more of the one or more frequencies.

The at least one memory and computer program code may be configured to, with the at least one processor, cause the master node to: receive from the secondary node an indication of one or more alternative measuring and/or reporting parameters for one or more of the one or more frequencies; and determine whether to accept use of the one or more alternative measuring and/or reporting parameters by the secondary node.

A secondary node for a dual connectivity user equipment, the secondary node comprising at least one processor, and at least one memory including computer program code, the at least one memory and computer program code configured to, with the at least one processor, cause the secondary node to perform: sending to a master node for the dual connectivity user equipment an indication of one or more frequencies for which the secondary node configures the dual connectivity user equipment to report measurement results to the secondary node; and receiving from the master node an indication of one or more measuring and/or reporting parameters for one or more of the one or more frequencies.

The at least one memory and computer program code may be configured to, with the at least one processor, cause the secondary node to determine at the secondary node whether to accept use of the one or more measuring and/or reporting parameters.

The at least one memory and computer program code may be configured to, with the at least one processor, cause the secondary node to: in the event of determining not to accept use of the one or more measuring and/or reporting parameters, send to the master node an indication of one or more alternative measuring and/or reporting parameters for one or more of the one or more frequencies.

A master node for a dual connectivity user equipment, the master node comprising: at least one processor, and at least one memory including computer program code, the at least one memory and computer program code configured to, with the at least one processor, cause the master node to perform: sending to a secondary node for the dual connectivity user equipment an indication of one or more rules for reporting measurement results or availability of measurement results to the master node for one or more frequencies for which the secondary node configures the dual connectivity user equipment to report measurement results to the secondary node.

A secondary node for a dual connectivity user equipment, the secondary node comprising: at least one processor, and at least one memory including computer program code, the at least one memory and computer program code configured to, with the at least one processor, cause the secondary node to perform: receiving from a master node for the dual connectivity user equipment an indication of one or more rules for reporting measurement results or availability of measurement results to the master node for one or more frequencies for which the secondary node configures the dual connectivity user equipment to report measurements to the secondary node; and sending one or more reporting messages to the master node according to the one or more rules.

The one or more rules may comprise one or more of: a rule to send a reporting message to the master node in response to an event at the secondary node; or a rule to periodically send reporting messages to the master node.

The event at the secondary node may comprise receiving measurement results from the dual connectivity user equipment.

A master node for a dual connectivity user equipment, the master node comprising: at least one processor, and at least one memory including computer program code, the at least one memory and computer program code configured to, with the at least one processor, cause the master node to perform: sending to the dual connectivity user equipment one or more messages configuring the dual connectivity user equipment to also report to the master node measurement results for one or more of one or more frequencies for which a secondary node for the dual connectivity user equipment configures the dual connectivity user equipment to report measurement results to the secondary node.

The one or more messages may indicate one or more links between one or more measurements configured by the master node and one or more measurements configured by the secondary node.

A dual connectivity user equipment comprising: at least one processor, and at least one memory including computer program code, the at least one memory and computer program code configured to, with the at least one processor, cause the dual connectivity user equipment to perform: receiving from a master node for the dual connectivity user equipment one or more messages configuring the dual connectivity user equipment to also report to the master node measurement results for one or more of the one or more frequencies for which the dual connectivity user equipment is configured by a secondary node for the dual connectivity user equipment to report measurement results to the secondary node.

The one or more messages may indicate one or more links between one or more measurements configured by the master node and one or more measurements configured by the secondary node; and the at least one memory and computer program code may be configured to, with the at least one processor, cause the dual connectivity user equipment to: in response to generating measurement results for reporting to the master node for measurements configured by the master node and indicated by the master node to be linked to measurements configured by the secondary node, reporting to the master node both the measurement results for the measurements configured by the master node and measurement results for the linked measurements configured by the secondary node.

A master node for a dual connectivity user equipment, the master node comprising: receiving circuitry for receiving from a secondary node for the dual connectivity user equipment an indication of one or more frequencies for which the secondary node configures the dual connectivity user equipment to report measurement results to the secondary node; and sending circuitry for sending to the secondary node an indication of one or more measuring and/or reporting parameters for one or more of the one or more frequencies.

A secondary node for a dual connectivity user equipment, the secondary node comprising: sending circuitry for sending to a master node for the dual connectivity user equipment an indication of one or more frequencies for which the secondary node configures the dual connectivity user equipment to report measurement results to the secondary node; and receiving circuitry for receiving from the master node an indication of one or more measuring and/or reporting parameters for one or more of the one or more frequencies.

A master node for a dual connectivity user equipment, comprising: sending circuitry for sending to a secondary node for the dual connectivity user equipment an indication of one or more rules for reporting measurement results or availability of measurement results to the master node for one or more frequencies for which the secondary node configures the dual connectivity user equipment to report measurement results to the secondary node.

A secondary node for a dual connectivity user equipment, comprising: receiving circuitry for receiving from a master node for the dual connectivity user equipment an indication of one or more rules for reporting measurement results or availability of measurement results to the master node for one or more frequencies for which the secondary node configures the dual connectivity user equipment to report measurements to the secondary node; and sending circuitry for sending one or more reporting messages to the master node according to the one or more rules.

A master node for a dual connectivity user equipment, comprising: sending circuitry for sending to the dual connectivity user equipment one or more messages configuring the dual connectivity user equipment to also report to the master node measurement results for one or more of one or more frequencies for which a secondary node for the dual connectivity user equipment configures the dual connectivity user equipment to report measurement results to the secondary node.

A dual connectivity user equipment, comprising: receiving circuitry for receiving from a master node for the dual connectivity user equipment one or more messages configuring the dual connectivity user equipment to also report to the master node measurement results for one or more of the one or more frequencies for which the dual connectivity user equipment is configured by a secondary node for the dual connectivity user equipment to report measurement results to the secondary node.

A computer readable medium comprising program instructions stored thereon for performing: receiving at a master node for a dual connectivity user equipment from a secondary node for the dual connectivity user equipment an indication of one or more frequencies for which the secondary node configures the dual connectivity user equipment to report measurement results to the secondary node; and sending from the master node to the secondary node an indication of one or more measuring and/or reporting parameters for one or more of the one or more frequencies.

A computer readable medium comprising program instructions stored thereon for performing: sending from a secondary node for a dual connectivity user equipment to a master node for the dual connectivity user equipment an indication of one or more frequencies for which the secondary node configures the dual connectivity user equipment to report measurement results to the secondary node; and
receiving at the secondary node from the master node an indication of one or more measuring and/or reporting parameters for one or more of the one or more frequencies.

A computer readable medium comprising program instructions stored thereon for performing: sending from a master node for a dual connectivity user equipment to a secondary node for the dual connectivity user equipment an indication of one or more rules for reporting measurement results or availability of measurement results to the master node for one or more frequencies for which the secondary node configures the dual connectivity user equipment to report measurement results to the secondary node.

A computer readable medium comprising program instructions stored thereon for performing: receiving at a secondary node for a dual connectivity user equipment from a master node for the dual connectivity user equipment an indication of one or more rules for reporting measurement results or availability of measurement results to the master node for one or more frequencies for which the secondary node configures the dual connectivity user equipment to report measurements to the secondary node; and sending one or more reporting messages to the master node according to the one or more rules.

A computer readable medium comprising program instructions stored thereon for performing: sending to a dual connectivity user equipment from a master node for the dual connectivity user equipment one or more messages configuring the dual connectivity user equipment to also report to the master node measurement results for one or more of one or more frequencies for which a secondary node for the dual connectivity user equipment configures the dual connectivity user equipment to report measurement results to the secondary node.

A computer readable medium comprising program instructions stored thereon for performing: receiving at a dual connectivity user equipment from a master node for the dual connectivity user equipment one or more messages configuring the dual connectivity user equipment to also report to the master node measurement results for one or more of the one or more frequencies for which the dual connectivity user equipment is configured by a secondary node for the dual connectivity user equipment to report measurement results to the secondary node.

A non-transitory computer readable medium comprising program instructions stored thereon for performing: receiving at a master node for a dual connectivity user equipment from a secondary node for the dual connectivity user equipment an indication of one or more frequencies for which the secondary node configures the dual connectivity user equipment to report measurement results to the secondary node; and sending from the master node to the secondary node an indication of one or more measuring and/or reporting parameters for one or more of the one or more frequencies.

A non-transitory computer readable medium comprising program instructions stored thereon for performing: sending from a secondary node for a dual connectivity user equipment to a master node for the dual connectivity user equipment an indication of one or more frequencies for which the secondary node configures the dual connectivity user equipment to report measurement results to the secondary node; and receiving at the secondary node from the master node an indication of one or more measuring and/or reporting parameters for one or more of the one or more frequencies.

A non-transitory computer readable medium comprising program instructions stored thereon for performing: sending from a master node for a dual connectivity user equipment to a secondary node for the dual connectivity user equipment an indication of one or more rules for reporting measurement results or availability of measurement results to the master node for one or more frequencies for which the secondary node configures the dual connectivity user equipment to report measurement results to the secondary node.

A non-transitory computer readable medium comprising program instructions stored thereon for performing: receiving at a secondary node for a dual connectivity user equipment from a master node for the dual connectivity user equipment an indication of one or more rules for reporting measurement results or availability of measurement results to the master node for one or more frequencies for which the secondary node configures the dual connectivity user equipment to report measurements to the secondary node; and sending one or more reporting messages to the master node according to the one or more rules.

A non-transitory computer readable medium comprising program instructions stored thereon for performing: sending to a dual connectivity user equipment from a master node for the dual connectivity user equipment one or more messages configuring the dual connectivity user equipment to also report to the master node measurement results for one or more of one or more frequencies for which a secondary node for the dual connectivity user equipment configures the dual connectivity user equipment to report measurement results to the secondary node.

A non-transitory computer readable medium comprising program instructions stored thereon for performing: receiving at a dual connectivity user equipment from a master node for the dual connectivity user equipment one or more messages configuring the dual connectivity user equipment to also report to the master node measurement results for one or more of the one or more frequencies for which the dual connectivity user equipment is configured by a secondary node for the dual connectivity user equipment to report measurement results to the secondary node.

A computer program comprising computer executable code which when run on at least one processor is configured to cause a master node for a dual connectivity user equipment at least to: receive from a secondary node for the dual connectivity user equipment an indication of one or more frequencies for which the secondary node configures the dual connectivity user equipment to report measurement results to the secondary node; and send to the secondary node an indication of one or more measuring and/or reporting parameters for one or more of the one or more frequencies.

A computer program comprising computer executable code which when run on at least one processor is configured to cause a secondary node for a dual connectivity user equipment at least to: send to a master node for the dual connectivity user equipment an indication of one or more frequencies for which the secondary node configures the dual connectivity user equipment to report measurement results to the secondary node; and receive from the master node an indication of one or more measuring and/or reporting parameters for one or more of the one or more frequencies.

A computer program comprising computer executable code which when run on at least one processor is configured to cause a master node for a dual connectivity user equipment at least to: send to a secondary node for the dual connectivity user equipment an indication of one or more rules for reporting measurement results or availability of measurement results to the master node for one or more frequencies for which the secondary node configures the dual connectivity user equipment to report measurement results to the secondary node.

A computer program comprising computer executable code which when run on at least one processor is configured to cause a secondary node for a dual connectivity user equipment at least to receive from a master node for the dual connectivity user equipment an indication of one or more rules for reporting measurement results or availability of measurement results to the master node for one or more frequencies for which the secondary node configures the dual connectivity user equipment to report measurements to the secondary node; and send one or more reporting messages to the master node according to the one or more rules.

A computer program comprising computer executable code which when run on at least one processor is configured to cause a master node for a dual connectivity user equipment at least to: send to the dual connectivity user equipment one or more messages configuring the dual connectivity user equipment to also report to the master node measurement results for one or more of one or more frequencies for which a secondary node for the dual connectivity user equipment configures the dual connectivity user equipment to report measurement results to the secondary node.

A computer program comprising computer executable code which when run on at least one processor is configured to cause a dual connectivity user equipment at least to: receive from a master node for the dual connectivity user equipment one or more messages configuring the dual connectivity user equipment to also report to the master node measurement results for one or more of the one or more frequencies for which the dual connectivity user equipment is configured by a secondary node for the dual connectivity user equipment to report measurement results to the secondary node.

In the above, many different aspects have been described. It should be appreciated that further aspects may be provided by the combination of any two or more of the aspects described above.

Various other aspects are also described in the following detailed description and in the attached claims.

### BRIEF DESCRIPTION OF THE FIGURES

Some example embodiments will now be described in further detail, by way of example only, with reference to the following examples and accompanying drawings, in which:

FIG. 1 shows an example mobile communication system to which some example embodiments may be applied;

FIG. 2 shows a representation of an example of operations of some elements of FIG. 1 according to some example embodiments;

FIG. 3 shows a representation of an example of operations of some elements of FIG. 1 according to some example embodiments;

FIG. 4 shows a representation of an example of operations of some elements of FIG. 1 according to some example embodiments;

FIG. 5 shows a representation of an example of operations of some elements of FIG. 1 according to some example embodiments;

FIG. 6 shows a representation of an example of operations of some elements of FIG. 1 according to some example embodiments;

FIG. 7 shows a representation of an example of operations of some elements of FIG. 1 according to some example embodiments;

FIG. 8 shows a representation of an example of operations of some elements of FIG. 1 according to some example embodiments;

FIG. 9 shows a representation of an example of operations of some elements of FIG. 1 according to some example embodiments;

FIG. 10 shows a representation of an example of operations of some elements of FIG. 1 according to some example embodiments;

FIG. 11 shows a representation of an example of apparatus for implementing user equipment functionality or access node functionality according to some example embodiments;

FIG. 12 shows a representation of an example of non-volatile memory media.

### DETAILED DESCRIPTION

By way of example, the following description focusses on an example involving a master node operating according to 3GPP 5G radio access technology, but the underlying technique may also be applicable to other examples involving master nodes operating according to other radio access technologies, such as more evolved 3GPP radio access technologies.

By way of example, the following description also focuses on the example of a secondary node being a node that operates according to the same radio access technology as the master node, but the underlying technique is also applicable to examples in which the master and secondary nodes operate according to different radio access technologies.

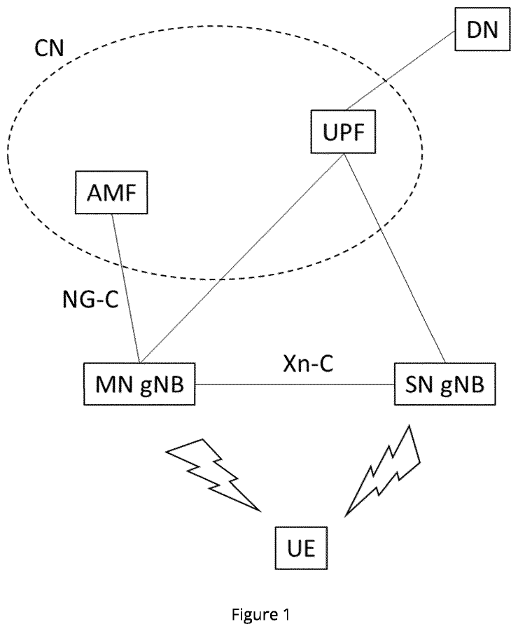

FIG. 1 shows a simple representation of one example of a 5G system architecture, showing some elements having a role in the example embodiments described below. All the units shown in FIG. 1 are logical units. The connections shown in FIG. 1 are logical connections; the actual physical connections may be different. A 5G system may comprise other functions and structures in addition to those shown in FIG. 1.

The 5G core network (CN) may provide connections between devices implementing user equipment functionality (UEs) and one or more data networks (DN) via a radio access network such as a New Generation Radio Access Network (NG-RAN) comprising a network of devices implementing instances of gNB (gNodeB) functionality.

A gNB is (i) connected to a user plane function (UPF) of the core network (CN), for routing and forwarding user data packets and for providing connectivity of devices to one or more external packet data networks (DN), and (ii) is connected to an access mobility management function (AMF) of the core network (CN) for controlling access and changes of serving cells for UEs.

The term “user equipment” (UE) may refer to any device, apparatus or component implementing at least 3GPP user equipment (UE) functionality.

The UE may be a mobile or static device (e.g. a portable or non-portable computing device) including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a UE device may also be a nearly exclusive uplink only device, of which an example is a camera or video camera loading images or video clips to a network. A UE device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a UE device may comprise a user portable device with radio parts (such as a watch, earphones or eyeglasses) and the computation is carried out in the cloud.

5G enables using multiple input-multiple output (MIMO) antennas, and may involve large numbers of base stations (gNBs) including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G may employ multiple frequency bands, e.g. below 6 GHz or above 24 GHz, cmWave and mmWave, and may also be integrable with other radio access technologies, such as LTE. 5G may support both inter-RAT operability (such as LTE-5G) and inter-RI operability (inter-radio interface operability, such as below 6 GHz-cmWave, 6 or above 24 GHz-cmWave and mmWave). 5G networks may employ network slicing, in which multiple independent and dedicated virtual sub-networks (network instances) may be created within the same infrastructure to run services that have different requirements on latency, reliability, throughput and mobility.

Low latency applications and services may be facilitated by bringing content close to the 5G system, which leads to local break out and multi-access edge computing (MEC). 5G enables analytics and knowledge generation to occur at the source of the data. This approach may involve leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

The 5GC adopts a service-based architecture (SBA) according to which communication between network functions uses Service Based Interfaces (SBIs). Application Programming Interfaces (APIs) are used for the SBIs.

A UE may be in dual connectivity with two or more access nodes; one access node operating as a master node (MN), and one or more access nodes operating as secondary nodes (SN). The control plane connection established for the dual connectivity UE between the core network (more particularly an instance of a 5G access and mobility management function (AMF) of 5G CN) and the radio access network terminates at the master node; there is no control plane connection established for the dual connectivity UE between the core network and a secondary node for the dual connectivity UE. User plane connections for the dual connectivity UE may be provided both between the MN and an instance of a 5G User Plan Function (UPF), and between the SN and the UPF instance. The MN provides primary radio resources for the dual connectivity UE via one or more cells (Master Cell Group (MCG)). A SN provides additional radio resources for the dual connectivity UE via one or more additional cells (Secondary Cell Group (SCG)).

A gNB operating as a master node for the dual connectivity UE and a gNB operating as a secondary node for the dual connectivity UE may exchange at least control plane information via a Xn interface between the two nodes.

According to one example, the node operating as a master node for the dual connectivity UE may be a macro base station having relatively wide radio coverage; and the node operating as a secondary node for the dual connectivity UE may be a non-macro node having a narrower radio coverage.

Both the master node and the secondary node have their own RRC entities that can generate RRC messages for the dual connectivity UE. RRC messages generated by the SN may be sent directly to the UE via a SN cell via a signalling radio bearer (SIB3) established between the DC-UE and SN. Alternatively, RRC messages generated by SN for the dual connectivity UE may be sent from the SN to the MN via the Xn interface, and then encapsulated in an RRC message generated by the MN and sent to UE via a MN cell via a signalling radio bearer (SRB1) established between the MN and the UE. RRC response messages generated by DC-UE in response to RRC messages from the SN may be sent directly to the SN via a SN cell. Alternatively, RRC response messages generated by DC-UE in response to RRC messages from the SN may be encapsulated in a RRC response message generated by DC-UE in response to a RRC message from MN; the encapsulated RRC response message for SN is forwarded by MN to SN over the Xn interface.

Both MN and SN configure UE to make and report measurements via RRC messages generated at MN and SN, respectively. Configuring UE to make and report measurements may involve using a Measurement ID to link a measurement object (MO) for the UE and a reporting configuration (RC) for the UE. The MO configures the UE for measurements; and may indicate e.g. one or more frequencies, one or more reference signals, one or more L3 filtering parameters etc. The RC configures the UE for reporting the performed measurements; and may e.g. configure the UE for periodic and/or event-triggered reporting.

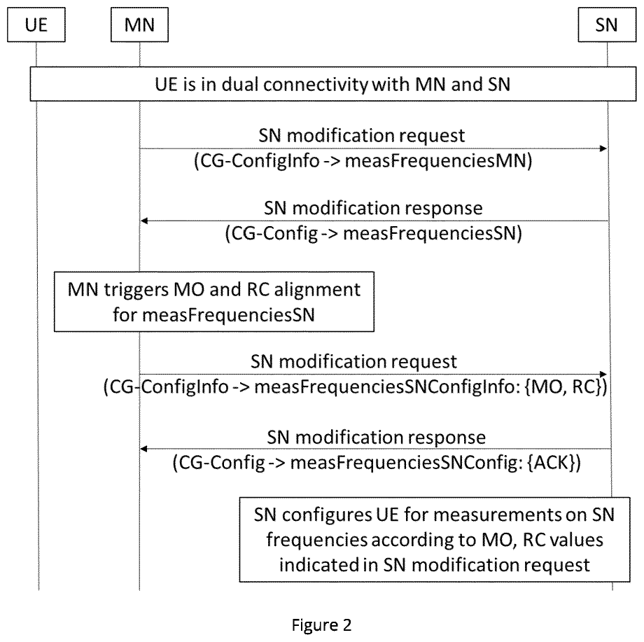

FIGS. 2 to 6 illustrate examples of operations at MN and SN according to some example embodiments. In this example, a DC-UE is in dual connectivity with a gNB acting as MN and a gNB acting as SN.

MN sends to SN via the Xn interface a SN modification request. The SN modification request comprises a CG-ConfigInfo message specified at Clause 11 of 3GPP TS38.331 V17.1.0, including CG-ConfigInfo information elements (IEs) shown below. The CG-ConfigInfo IEs include a measConfigMN IE indicating the measurement configuration of MN. The measConfigMN IE indicates the frequencies (measFrequenciesMN) for which the MN configures DC-UE to make and report measurements.

| | |
|---|---|
| CG-ConfigInfo-IEs ::= | SEQUENCE ( |
| ue-CapabilityInfo | OCTET STRING (CONTAINING UE-CapabilityRAT-ContainerList) |
| candidateCellInfoListMN | MeasResultList2NR |
| candidateCellInfoListSN | OCTET STRING (CONTAINING MeasResultList2NR) |
| measResultCellListSFTD-NR | MeasResultCellListSFTD-NR |
| scgFailureInfo | SEQUENCE ( |
| failureType | ENUMERATED ( t310-Expiry, randomAccessProblem, |
| | rlc-MaxNumRetx, synchReconfigFailure-SCG, |
| | scg-reconfigFailure, |
| | srb3-IntegrityFailure), |
| measResultSCG | OCTET STRING (CONTAINING MeasResultSCG-Failure) |

)

| | |
|---|---|
| configRestrictInfo | ConfigRestrictInfoSCG |
| drx-InfoMCG | DRX-Info |
| measConfigMN | MeasConfigMN |
| sourceConfigSCG | OCTET STRING (CONTAINING RRCReconfiguration) |
| scg-RB-Config | OCTET STRING (CONTAINING RadioBearerConfig) |
| mcg-RB-Config | OCTET STRING (CONTAINING RadioBearerConfig) |
| mrdc-AssistanceInfo | MRDC-AssistanceInfo |
| nonCriticalExtension | CG-ConfigInfo-v1540-IEs |

)

In reply to the SN modification request message from MN, SN sends to MN via the Xn interface a SN modification response. The SN modification response comprises a CG-Config message specified at Clause 11 of 3GPP TS38.331 V17.1.0, including CG-Config IEs shown below. The CG-Config IEs include a measConfigSN IE indicating the measurement configuration of SN. The measConfigSN IE indicates the frequencies (measFrequenciesSN) for which the SN configures DC-UE to make and report measurements.

| | |
|---|---|
| CG-Config-IEs ::= | SEQUENCE ( |
| scq-CellGroupConfig | OCTET STRING (CONTAINING RRCReconfiguration) |
| scg-RB-Config | OCTET STRING (CONTAINING RadioBearerConfig) |
| configRestrictModReq | ConfigRestrictModReqSCG |
| drx-InfoSCG | DRX-Info |
| candidateCellInfoListSN | OCTET STRING (CONTAINING MeasResultList2NR) |
| measconfigSN | MeasConfigSN |
| selectedBandcombination | BandCombinationInfoSN |
| fr-InfoListSCG | FR-InfoList |
| candidateServingFreqListNR | CandidateServingFreqListNR |
| nonCriticalExtension | CG-Config-v1540-IEs |

)

The SN and MN thus exchange lists of frequencies for which they configure DC-UE for measurements and reporting.

MN determines a preference for the MO and RC parameters for measFrequenciesSN. For example, MN may determine a preference to align the MO and RC parameters for one or more measFrequenciesSN with one the MO and RC parameters for one or more measFrequenciesMN.

MN sends a SN modification request to SN. The SN modification request comprises a CG-ConfigInfo message. The CG-ConfigInfo message includes an information element (measFrequenciesSNConfigInfo) indicating the MN preference for the MO parameters and RC settings for measFrequenciesSN.

SN determines whether it can accept the MN preference for the MO parameters and RC settings for measFrequenciesSN.

In FIG. 2, the result of this determination at SN is positive, and SN replies to the SN modification request from MN by sending a SN modification response indicating a positive acknowledgment (ACK).

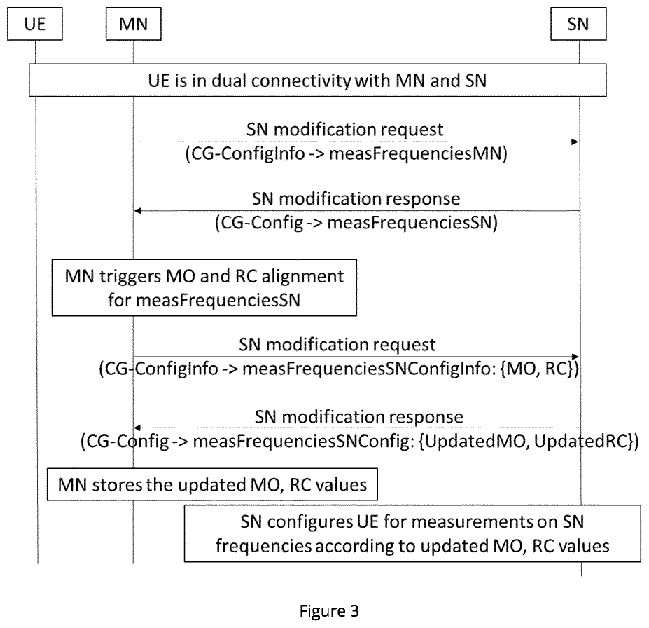

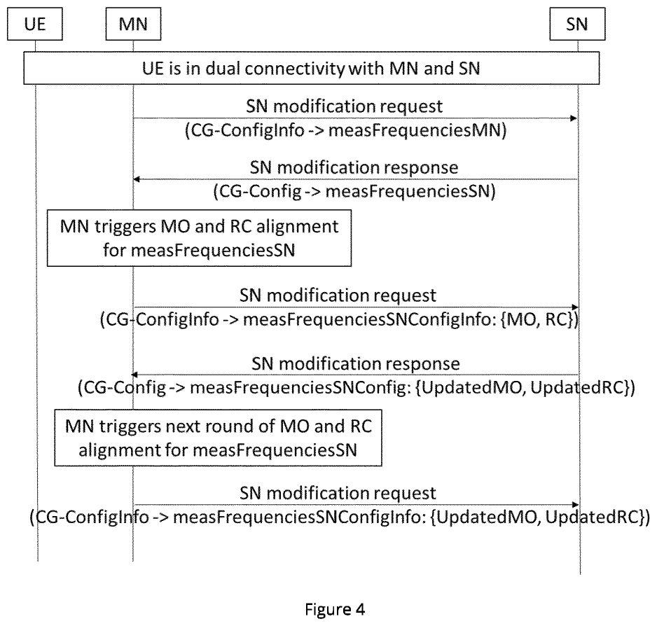

In FIGS. 3 and 4, the result of the determination at SN is negative, and SN replies to the SN modification request from MN by sending a SN modification response indicating the SN preference for the MO parameters and RC settings for measFrequenciesSN. The SN preference may be partly based on the MN preference indicated in the SN modification request from MN.

MN determines whether it can accept the SN preference for the MO parameters and RC settings for measFrequenciesSN.

In FIG. 3, the result of this determination at MN is positive. MN acknowledges acceptance of the SN preference to SN. SN configures DC-UE for measurements according to the SN preference for the MO parameters and RC settings for measFrequenciesSN.

In FIG. 4, the result of the determination at MN is negative. MN sends a new SN modification request to the SN via the Xn interface. The new SN modification request comprises a CG-ConfigInfo message. The CG-ConfigInfo message includes an information element (measFrequenciesSNConfigInfo) indicating the new MN preference for the MO parameters and RC settings for measFrequenciesSN. The determination of the new MN preference at MN may be partly based on the SN preference indicated in the SN modification response from SN.

This exchange of preferences for the MO parameters and RC settings for measFrequenciesSN continues until either SN accepts a MN preference for the MO parameters and RC settings for measFrequenciesSN or MN accepts a SN preference for the for the MO parameters and RC settings for measFrequenciesSN.

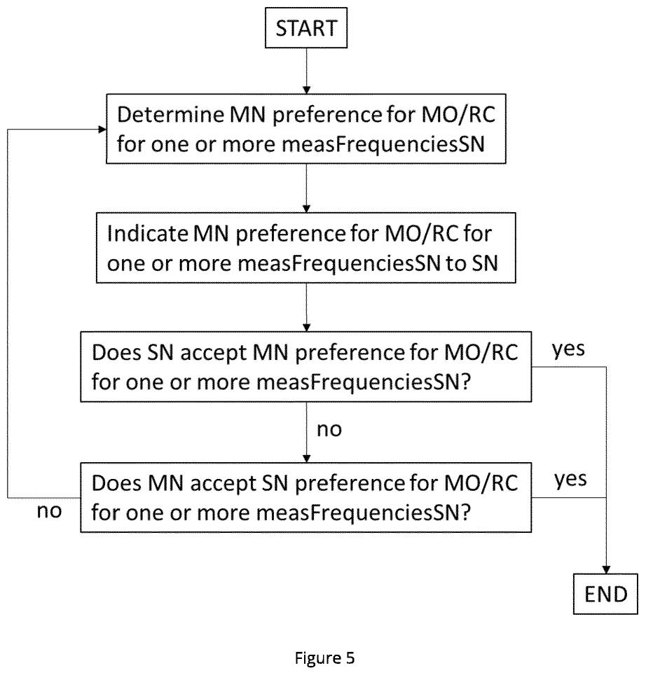

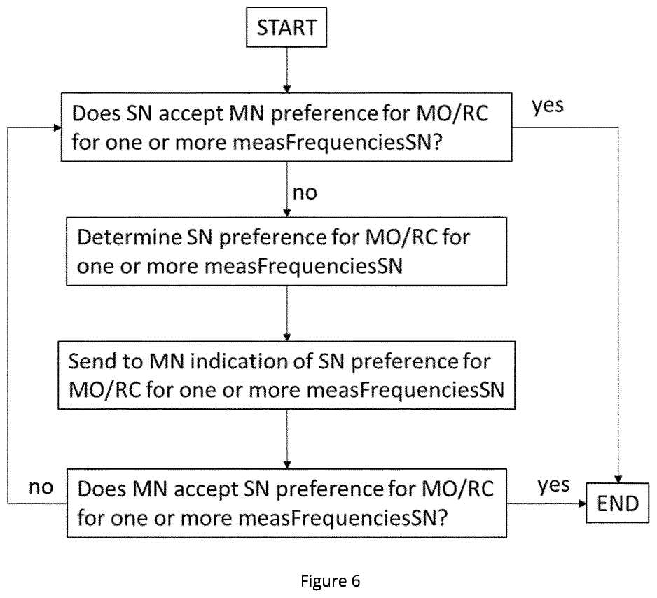

FIG. 5 shows a representation of operations of MN in the examples of FIGS. 2 to 4; and FIG. 6 shows a representation of operations of SN in the examples of FIGS. 2 to 4.

These example techniques may facilitate improved co-ordination between MN and SN for e.g. alignment of MO parameters and RC settings for DC-UE measurements configured by MN and DC-UE measurements configured by SN. This can facilitate a reduction in double measurements, and can aid in the efficient use of MN-configured measurement gaps for SN-configured measurements.

For example, these example techniques may avoid DC-UE being configured by MN and SN with different measurement objects and reporting configurations for the same measurement frequency. These example techniques can reduce the risk of interruption time if some measurement gap is needed, and/or can reduce incidences of DC-UE not considering the measurement of such frequency as a single layer, ending with inefficient usage of processing capacity at the UE for measurements. These example techniques may be particularly useful, for example, in the event that the MN does not wish to measure the same frequency as SN, but would like to propose and recommend parameter settings for measurement objects and reporting configurations.

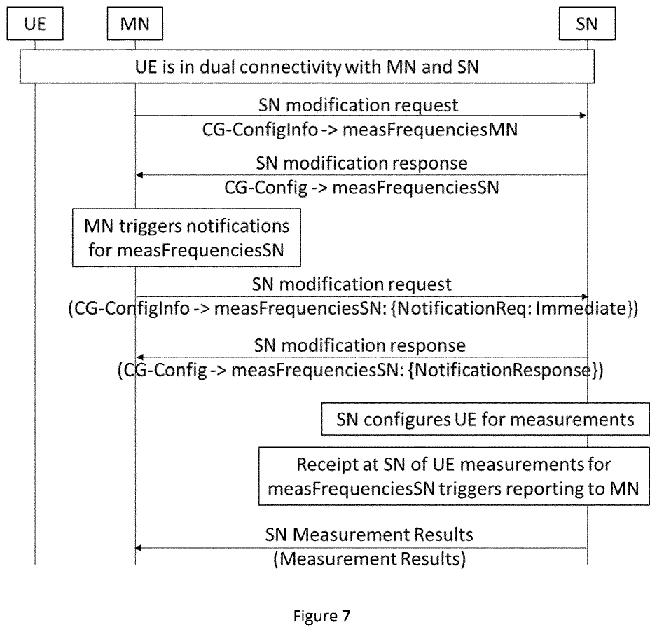

FIGS. 7 to 9 show a representation of operations at nodes acting as MN and SN for a DC-UE according to some example embodiments.

MN sends to SN via the Xn interface a SN modification request. The SN modification request comprises a CG-ConfigInfo message, including CG-ConfigInfo information elements (IEs) described above. The CG-ConfigInfo IEs include a measConfigMN IE indicating the measurement configuration of MN. The measConfigMN IE indicates the frequencies (measFrequenciesMN) for which MN configures DC-UE to make and report measurements.

In reply to the SN modification request from MN, SN sends to MN via the Xn interface a SN modification response. The SN modification response comprises a CG-Config message, including CG-Config IEs described above. The CG-Config IEs include a measConfigSN IE indicating the measurement configuration of SN. The measConfigSN IE indicates the frequencies (measFrequenciesSN) for which SN configures DC-UE to make and report measurements.

MN triggers a request to SN for notifications related to measurements for measFrequenciesSN according to one or more rules.

In FIG. 7, MN sends to SN a request for SN to share measurement results for measFrequenciesSN immediately upon receiving measurement results for measFrequenciesSN from DC-UE. The SN modification request sent to SN comprises a CG-ConfigInfo IE including a notification request (NotificationReq) field populated by a value indicating a request for SN to share measurement results for measFrequenciesSN with MN immediately upon receiving measurement results for measFrequenciesSN from DC-UE. SN replies to the SN notification request from MN by sending a SN modification response indicating acceptance of the MN request. SN generates a RRC message for DC-UE configuring DC-UE for measurement of measFrequenciesSN and reporting of measurement results for measFrequenciesSN. The RRC message may be sent directly to DC-UE via a signalling radio bearer (SRB3) established between SN and DC-UE, or may be sent to DC-UE via MN and a signalling radio bearer (SRB1) established between MN and DC-UE. In response to receiving measurement results for measFrequenciesSN from DC-UE, SN shares the measurement results with MN, according to the rule indicated in the SN modification request from MN.

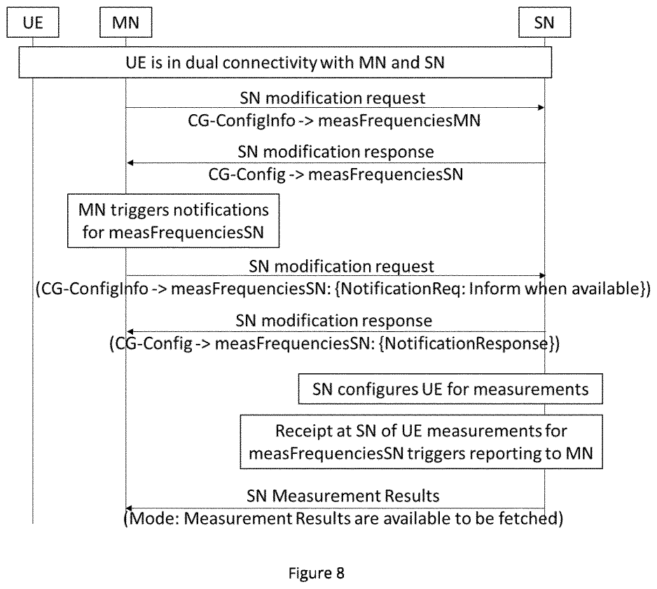

In FIG. 8, MN sends to SN a request for SN to notify MN about availability of new measurement results whenever SN receives new measurement results for measFrequenciesSN from DC-UE (without automatically sending the new measurement results from SN to MN). The SN modification request sent from MN to SN comprises a CG-ConfigInfo IE including a notification request (NotificationReq) field populated by a value indicating a request for SN to inform MN about availability of new DC-UE measurement results for measFrequenciesSN at SN. SN replies to the SN notification request from MN by sending a SN modification response indicating acceptance of the MN request. SN generates a RRC message for DC-UE configuring DC-UE for measurement of measFrequenciesSN and reporting of measurement results for measFrequenciesSN. The RRC message may be sent directly to DC-UE via a signalling radio bearer (SRB3) established between SN and DC-UE, or may be sent to DC-UE via MN and a signalling radio bearer (SRB1) established between MN and DC-UE. In response to receiving measurement results for measFrequenciesSN from DC-UE, SN sends a message to MN indicating that new DC-UE measurement results for measFrequenciesSN are available to be fetched by MN from SN. MN may determine to fetch the measurement results from SN. MN may use a SN modification request message to fetch the measurement results.

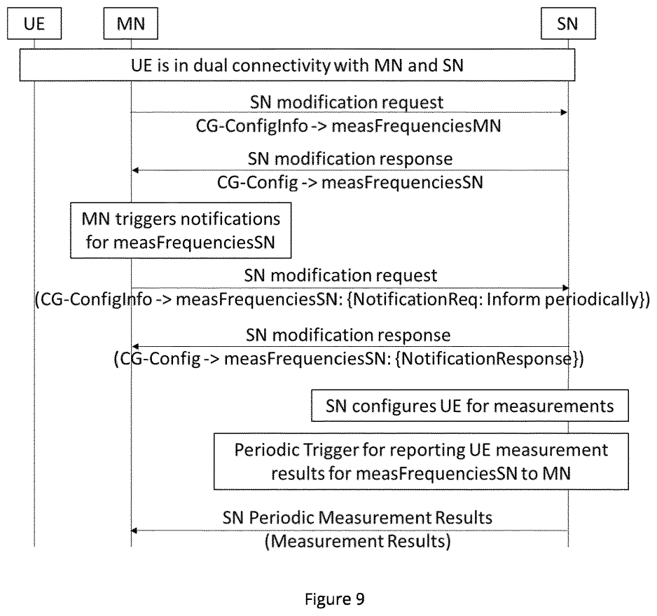

In FIG. 9, MN sends to SN a request for SN to periodically share the latest DC-UE measurement results for measFrequenciesSN with MN. The SN modification request sent to SN comprises a CG-ConfigInfo IE including a notification request (NotificationReq) field populated by a value indicating a request for SN to periodically share the latest DC-UE measurement results for measFrequenciesSN with MN. SN replies to the SN notification request from MN by sending a SN modification response indicating acceptance of the MN request. SN generates a RRC message for DC-UE configuring DC-UE for measurement of measFrequenciesSN and reporting of measurement results for measFrequenciesSN. The RRC message may be sent directly to DC-UE via a signalling radio bearer (SRB3) established between SN and DC-UE, or may be sent to DC-UE via MN and a signalling radio bearer (SRB1) established between MN and DC-UE. SN periodically sends messages to MN including the latest DC-UE measurement results for measFrequenciesSN.

According to some example variations, the rules about SN reporting new DC-UE measurement results (or availability of new DC-UE measurement results) to MN may be qualified by one or more conditions. For example, MN may request SN to make the reporting to MN of new DC-UE measurement results conditional on a determination that DC-UE is moving at a speed greater than a threshold speed, or conditional on DC-UE being served by specific radio beams for SN.

These example techniques facilitate the reporting of SN-configured measurements to MN; and can avoid MN having to always individually fetch SN-configured measurement results, which would require two messages (request and response) over the Xn interface for each individual fetching operation.

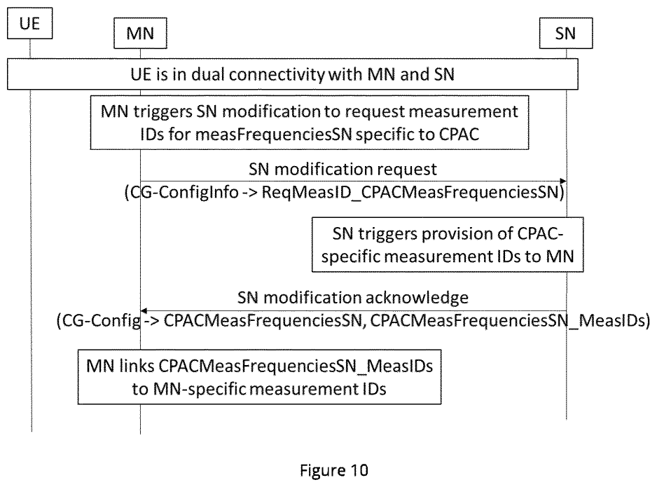

FIG. 10 shows an example of operations at DC-UE, MN and SN according to some example embodiments.

UE is in dual connectivity with two gNBs operating as MN and SN.

MN triggers the sending to SN of a request for an indication of which measFrequenciesSN (frequencies for which SN configures DC-UE for measurement reporting) are specific to a determination about whether conditions are met for a conditional PSCell addition/change (CPAC), wherein a PSCell is a primary SCG cell. The request from MN to SN includes a CG-ConfigInfo message including a request for an indication of which measFrequenciesSN (measurement frequencies for which SN configures DC-UE for measurement reporting) are specific to CPAC.

SN sends a SN modification acknowledgement in response to the request from MN. The SN modification acknowledgement comprises a CG-Config message indicating which measFrequenciesSN are specific to CPAC (CPACMeasFrequenciesSN) and indicating the measurement IDs for CPACMeasFrequenciesSN.

MN maps the measurement IDs for CPACMeasFrequenciesSN to one or more measurement IDs for MeasFrequenciesMN (measurement frequencies for which MN configures UE for measurement reporting). For example, MN maps the measurement IDs for CPACMeasFrequenciesSN to one or more measurement IDs for measurement frequencies for which MN configures UE for measurements) in relation to detecting an A3 or A5 event. An A3 event is triggered when RSRP (reference signal received power) or RSRQ (reference signal received quality) for a neighbouring cell becomes better than RSRP or RSRQ for the serving cell by an offset. An A5 event is triggered when the RSRP or RSRQ of the serving cell becomes worse than a first threshold value and RSRP or RSRQ of a neighbouring cell becomes better than second threshold value.

MN sends a RRC reconfiguration message to DC-UE. The reconfiguration message includes information about links between MN measurement IDs and SN measurement IDs; and DC-UE stores this information.

When reporting measurement results for a MN-configured measurement ID, DC-UE determines whether information received from MN (and stored at DC-UE) indicates a link between the MN-configured measurement ID and one or more SN-configured measurement IDs. If the result of the determination is positive, DC-UE includes the latest measurement results for the one or more SN-configured measurement IDs linked to the MN-configured measurement ID in the message to MN reporting the measurement results for the MN-configured measurement ID. In the event that measurement results for the one or more linked SN-configured measurement IDs are not fully available (e.g. because the measurements are at a preliminary stage), DC-UE nevertheless includes results of the incomplete measurements for the one or more linked SN-configured measurement IDs in the reporting message to MN, together with an indication of the incomplete status (e.g. L3 filtering ongoing, TTT (Time-To-Trigger) not expired). In the event that the measurement results for the one or more linked SN-configured measurement IDs are fully available but are yet to be reported to SN, DC-UE includes the completed measurement results for the one or more linked SN-configured measurement IDs in the reporting message to MN. The DC-UE may or may not indicate in the message to MN that the completed measurement results are yet to be reported to the SN.

MN may use these measurement results for one or more linked SN-configured measurement IDs for, for example, the purpose of narrowing down a list of candidate nodes to be prepared as secondary nodes for a DC conditional handover (CHO).

These example techniques allow MN to receive CPAC-related SN-configured measurement results directly from DC-UE; and avoid the overheads involved with receiving CPAC related SN-configured measurements via SN.

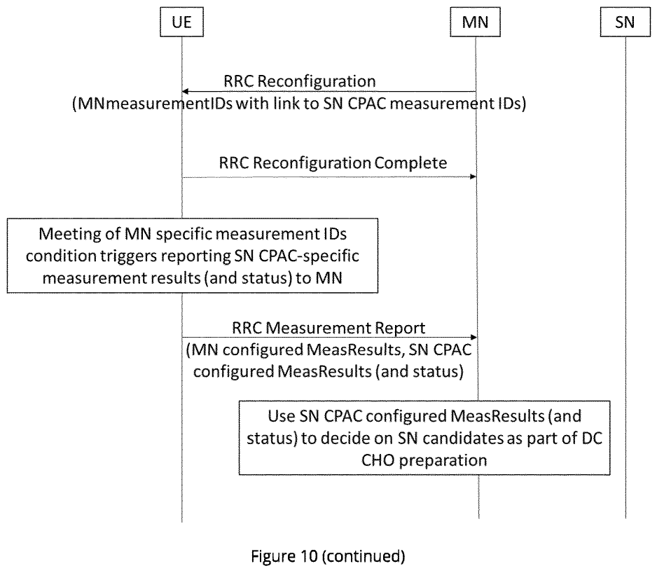

FIG. 11 illustrates an example of an apparatus for implementing UE or access node (master node or secondary node) functionality in the architecture of FIG. 1. The apparatus may include at least one processor 802 coupled to one or more interfaces 808. For a UE, the one or more interfaces 808 may include one or more interfaces to e.g. other equipment/component(s) for which the UE functionality provides radio communications. For a access node, the one or more interfaces 808 may include one or more interfaces to e.g. core network nodes implementing core network functions such as AMF, UPF etc.) and other access nodes of the radio access network (RAN). The at least one processor 802 is also coupled to a radio unit 804 including one or more antennas etc. for making and receiving radio transmissions. The at least one processor 802 may also be coupled to at least one memory 806. The at least one processor 802 may be configured to execute an appropriate software code to perform the operations described above. The software code may be stored in the memory 806.

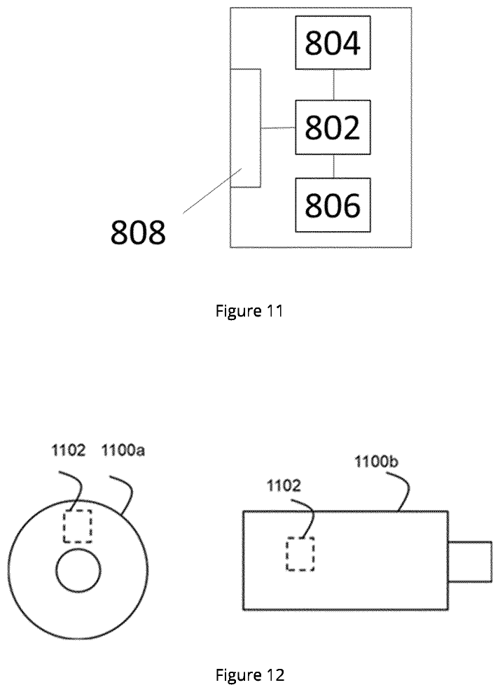

FIG. 12 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this document, a “computer-readable medium” may be any media or means that can contain, store, communicate, propagate or transport the instructions for use by or in connection with an instruction execution system, apparatus, or device, such as the base stations or user equipment of the above-described example embodiments.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as the user equipment or base stations of the above-described embodiments, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The features, advantages, and characteristics described herein can be combined in any suitable manner in one or more example embodiments. One skilled in the relevant art will recognize that such example embodiments can be practiced without one or more of the specific features or advantages of a particular embodiment. In other instances, additional features and advantages can be recognized in certain embodiments that may not be present in all example embodiments. One having ordinary skill in the art will readily understand that the example embodiments as discussed above may be practiced with steps in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1.-26. (canceled)

27. A master node for a dual connectivity user equipment, the master node comprising:
at least one processor; and at least one memory including computer program code, the at least one memory and computer program code configured to, with the at least one processor, cause the master node to perform:
receiving from a secondary node for the dual connectivity user equipment an indication of one or more frequencies for which the secondary node configures the dual connectivity user equipment to report measurement results to the secondary node; and
sending to the secondary node an indication of one or more measuring and/or reporting parameters for one or more of the one or more frequencies.

28. The master node according to claim 27, wherein the at least one memory and computer program code are configured to, with the at least one processor, cause the master node to:
receive from the secondary node an indication of one or more alternative measuring and/or reporting parameters for one or more of the one or more frequencies; and
determine whether to accept use of the one or more alternative measuring and/or reporting parameters by the secondary node.

29. A secondary node for a dual connectivity user equipment, the secondary node comprising at least one processor; and at least one memory including computer program code, the at least one memory and computer program code configured to, with the at least one processor, cause the secondary node to perform:
sending to a master node for the dual connectivity user equipment an indication of one or more frequencies for which the secondary node configures the dual connectivity user equipment to report measurement results to the secondary node; and
receiving from the master node an indication of one or more measuring and/or reporting parameters for one or more of the one or more frequencies.

30. The secondary node according to claim 29, wherein the at least one memory and computer program code are configured to, with the at least one processor, cause the secondary node to determine at the secondary node whether to accept use of the one or more measuring and/or reporting parameters.

31. The secondary node according to claim 30, wherein the at least one memory and computer program code are configured to, with the at least one processor, cause the secondary node to:
in the event of determining not to accept use of the one or more measuring and/or reporting parameters, send to the master node an indication of one or more alternative measuring and/or reporting parameters for one or more of the one or more frequencies.

32. The master node of claim 27, wherein sending to the secondary node an indication of one or more measuring and/or reporting parameters for one or more of the one or more frequencies comprises:
sending to the secondary node an indication of one or more rules for reporting measurement results or availability of measurement results to the master node for one or more frequencies for which the secondary node configures the dual connectivity user equipment to report measurement results to the secondary node.

33. The secondary node of claim 29, wherein receiving from the master node an indication of one or more measuring and/or reporting parameters for one or more of the one or more frequencies comprises:
receiving from the master node an indication of one or more rules for reporting measurement results or availability of measurement results to the master node for one or more frequencies for which the secondary node configures the dual connectivity user equipment to report measurements to the secondary node; and
sending one or more reporting messages to the master node according to the one or more rules.

34. The secondary node according to claim 32, wherein the one or more rules comprise one or more of: a rule to send a reporting message to the master node in response to an event at the secondary node; or a rule to periodically send reporting messages to the master node.

35. The secondary node according to claim 34, wherein the event at the secondary node comprises receiving measurement results from the dual connectivity user equipment.

36. The master node of claim 27, wherein
the at least one memory and computer program code are further configured to, with the at least one processor, cause the master node to perform:
sending to the dual connectivity user equipment one or more messages configuring the dual connectivity user equipment to also report to the master node measurement results for one or more of one or more frequencies for which a secondary node for the dual connectivity user equipment configures the dual connectivity user equipment to report measurement results to the secondary node.

37. The master node according to claim 36, wherein the one or more messages indicate one or more links between one or more measurements configured by the master node and one or more measurements configured by the secondary node.

38. A dual connectivity user equipment comprising:
at least one processor; and at least one memory including computer program code, the at least one memory and computer program code configured to, with the at least one processor, cause the dual connectivity user equipment to perform:
receiving from a master node for the dual connectivity user equipment one or more messages configuring the dual connectivity user equipment to also report to the master node measurement results for one or more of the one or more frequencies for which the dual connectivity user equipment is configured by a secondary node for the dual connectivity user equipment to report measurement results to the secondary node.

39. The dual connectivity user equipment according to claim 38, wherein the one or more messages indicate one or more links between one or more measurements configured by the master node and one or more measurements configured by the secondary node; and
wherein the at least one memory and computer program code are configured to, with the at least one processor, cause the dual connectivity user equipment to: in response to generating measurement results for reporting to the master node for measurements configured by the master node and indicated by the master node to be linked to measurements configured by the secondary node, reporting to the master node both the measurement results for the measurements configured by the master node and measurement results for the linked measurements configured by the secondary node.

40.-63. (canceled)
